(19) United States
(12) Patent Application Publication
(10) Pub. No.: US 2008/0170002 A1
(43) Pub. Date: Jul. 17, 2008

(54) Method of driving Plasma Display Panel (PDP)

(76) Inventors: Sang-Young Lee, Suwon-si (KR); Kwang-Ho Jin, Suwon-si (KR); Sun-Kyung Ahn, Suwon-si (KR); Jung-Jin Choi, Suwon-si (KR)

Correspondence Address: ROBERT E. BUSHNELL, 1522 K STREET NW, SUITE 300, WASHINGTON, DC, 20005-1202, US

(21) Appl. No.: 12/000,543

(22) Filed: Dec. 13, 2007

(30) Foreign Application Priority Data
Dec. 21, 2006 (KR) 10-2006-0132037

(51) Int. Cl. G09G 3/28

(52) U.S. Cl. 345/63

(57) ABSTRACT

A method of driving a Plasma Display Panel (PDP) while improving a brightness saturation phenomenon that is caused by an increase in the total number of sustain discharge pulses. A sustain discharge is performed by a plurality of first and second electrodes, a number of sustain discharge pulses for a subfield is provided based on a rate of load of an input signal, and first and second voltages are alternately and respectively supplied to the first and second electrodes in a sustain period according to the provided number of the sustain discharge pulses, the second voltage being greater than the first voltage. A duration in which the first voltage is increased to the second voltage is inversely proportional to the number of sustain discharge pulses for the subfield.

### CLAIM OF PRIORITY

This application makes reference to, incorporates the same herein, and claims all benefits accruing under 35 U.S.C.§119 from an application for FIELD EMISSION DEVICE AND METHOD OF MANUFACTURING THE SAME earlier filed in the Korean Intellectual Property Office on Sep. 14, 2005 and there duly assigned Serial No. 10-2004-0073365.

### BACKGROUND OF THE INVENTION

1. Field of the Invention

The present invention relates to a method of driving a Plasma Display Panel (PDP), and more particularly, the present invention relates to a method of driving a PDP while improving a brightness saturation phenomenon which is caused by an increase in the number of sustain discharge pulses.

2. Description of the Related Art

PDPs, which are large-scale flat display devices, display an image by exciting phosphors in a predetermined pattern, using ultraviolet rays generated by supplying a discharge voltage between two substrates in which a plurality of electrodes are formed and which are sealed with a discharge gas.

An apparatus which drives a PDP includes a plurality of voltage sources that supply a driving signal to a plurality of electrodes aligned in the PDP, a plurality of switching devices, and a plurality of driving Integrated Circuits (ICs) that control the switching operations of the switching devices. The switching operations of the switching devices cause the driving signal to be output from the apparatus.

In general, in a PDP, a frame, which is a display cycle, is divided and driven in a plurality of subfields, and gray scales are expressed by a combination of subfields. Each of the subfields includes a reset period, an address period, and a sustain period. In the reset period, wall charges are set up so as to cancel wall charges formed by a previous sustain discharge and stably perform a next address discharge. In the address period, cells that are to be turned on and cells that are not to be turned on are selected in the panel, and wall charges are accumulated in the cells that are to be turned on (addressed cells). In the sustain period, a sustain discharge is performed in order to actually display an image in the addressed cells.

The brightness of the PDP is proportional to the total number of sustain discharge pulses in a sustain period in a unit frame.

However, as illustrated in FIG. 1, brightness is inversely proportional to the total number of sustain discharge pulses when a conventional plasma display driving method is performed. That is, an increase in the total number of sustain discharge pulses leads to the brightness saturation phenomenon.

That is, the more sustain discharge pulses there are, the lower the brightness. Therefore, the luminance efficiency per sustain discharge pulse is degraded, and thus, the actual brightness is lower than the estimated brightness. The brightness saturation phenomenon causes a degradation in image quality, such as a gray-scale inversion phenomenon.

### SUMMARY OF THE INVENTION

The present invention provides a method of driving a Plasma Display Panel (PDP) while improving a brightness saturation phenomenon that is caused by an increase in the total number of sustain discharge pulses.

According to an aspect of the present invention, a method of driving a Plasma Display Panel (PDP) in which a sustain discharge is performed by a plurality of first and second electrodes is provided, the method including: providing a number of sustain discharge pulses for a subfield based on a rate of load of an input signal; and alternately and respectively supplying first and second voltages to the first and second electrodes in a sustain period according to the provided number of sustain discharge pulses, the second voltage being greater than the first voltage; a duration in which the first voltage is increased to the second voltage, is inversely proportional to the number of sustain discharge pulses for the subfield.

Providing the number of sustain discharge pulses may include obtaining a number of sustain discharge pulses for each frame which is inversely proportional to the rate of load of the input signal; and obtaining a number of sustain discharge pulses for each subfield in accordance with the number of sustain discharge pulses for each frame and a weight allocated to each subfield.

When the number of sustain discharge pulses for the subfield is less than a predetermined number, the duration in which the voltage is increased from the first voltage to the second voltage may be kept constant.

When the number of sustain discharge pulses for the subfield is less than 100, the duration in which the voltage is increased from the first voltage to the second voltage may be kept constant.

The subfields may be divided into a plurality of groups according to a limit of the sustain discharge pulses for the subfield; the duration in which the voltage is increased from the first voltage to the second voltage may be the same for the subfields belonging to each group.

The more sustain discharge pulses there are belonging to a group, the greater limit the sustain discharge pulses belonging to the group have.

The number of the sustain discharge pulses for each subfield may be calculated by multiplying a ratio of a weight for the subfield to a weight for the frame by the number of sustain discharge pulses for the frame.

The duration that the voltage is increased from the first voltage to the second voltage may be controlled according to the timing of a switch of an energy recovery circuit which is electrically connected to either the first electrodes or the second electrodes.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a graph of an increasing rate of brightness versus the number of sustain discharge pulses, when a conventional plasma display driving method is performed;

FIG. 2 is a view of an example of a Plasma Display Panel (PDP) driven by a plasma display driving method according to an embodiment of the present invention;

FIG. 3 is a cross-sectional view of a unit display cell of the PDP of FIG. 2;

FIG. 4 is a schematic diagram of the arrangement of electrodes in the PDP of FIG. 2;

FIG. 5 is a timing diagram of a method of driving the PDP of FIG. 2 according to an embodiment of the present invention;

FIG. 6 is a schematic block diagram of an apparatus for driving a PDP, according to an embodiment of the present invention;

FIG. 7 is a schematic block diagram of a controller included in a PDP according to an embodiment of the present invention;

FIG. 8 is a table of a method of differently controlling the amount of time required to achieve a sustain discharge pulse voltage according to an embodiment of the present invention;

FIG. 9 is a circuit diagram of an energy recovery circuit that supplies the sustain discharge pulse voltage to a scan electrode or a sustain electrode;

FIGS. 10A and 10B are waveforms of variations in an optical output versus a rising ramp of a sustain discharge pulse; and

FIG. 11 is a graph of an improvement in the brightness saturation phenomenon, according to an embodiment of the present invention.

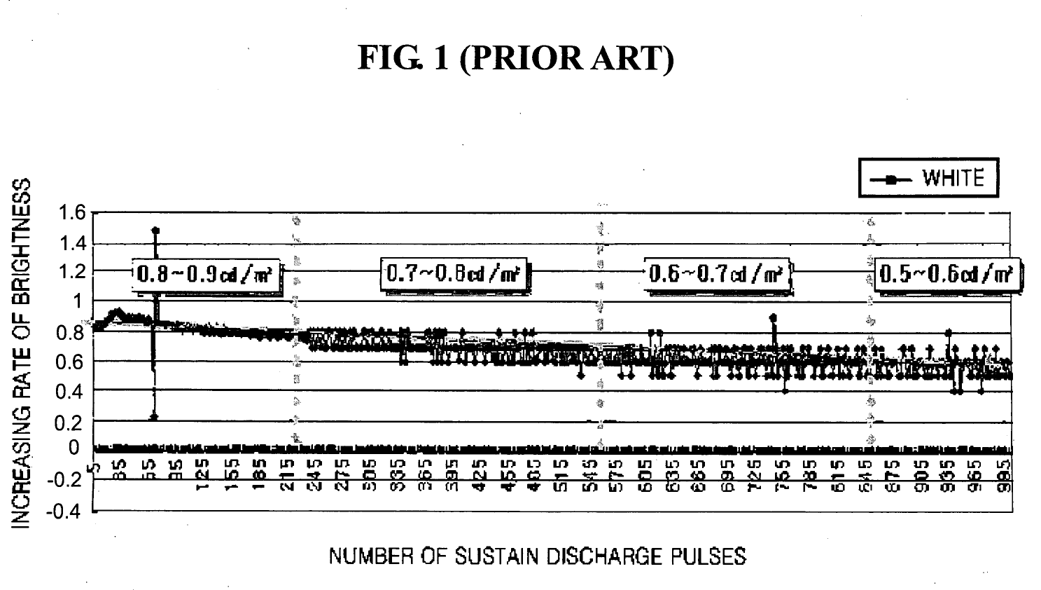

### DETAILED DESCRIPTION OF THE INVENTION

Hereinafter, exemplary embodiments of the present invention are described in detail with reference to the accompanying drawings.

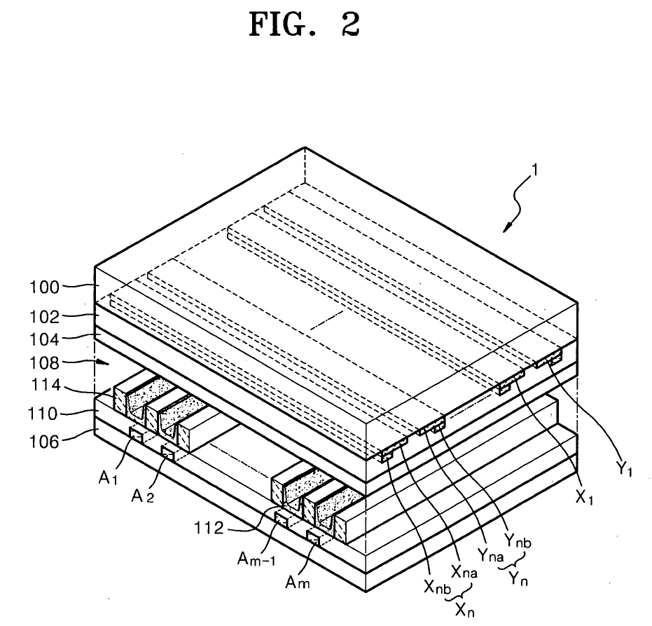

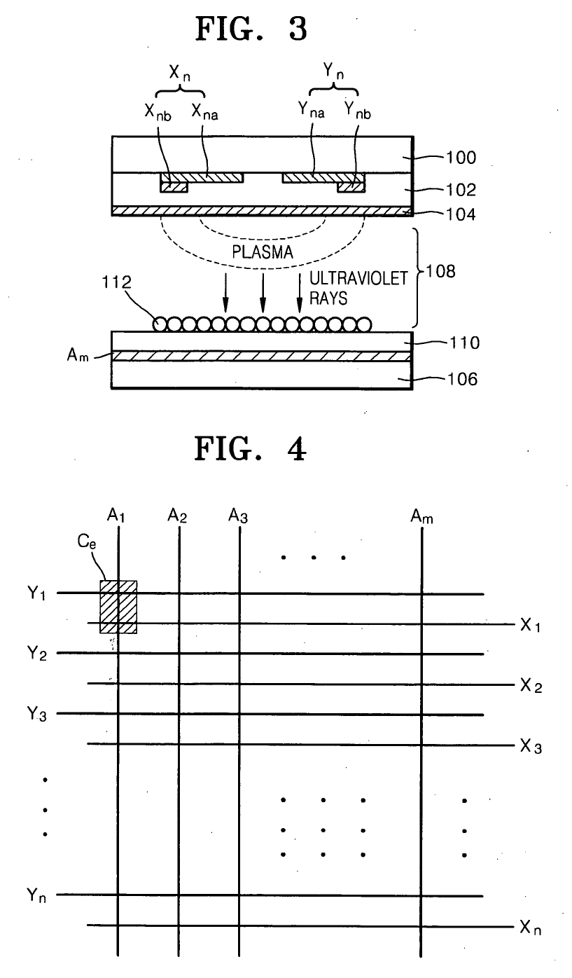

FIG. 2 is a view of an example of a Plasma Display Panel (PDP) 1 driven according to a plasma panel driving method according to an embodiment of the present invention. FIG. 3 is a cross-sectional view of a unit display cell of the PDP 1 of FIG. 2.

Referring to FIGS. 2 and 3, A electrodes A1 through to Am, first and second dielectric layers 102 and 110, Y electrodes Y1 through to Yn, X electrodes X1 through to Xn, phosphor layers 112, barrier ribs 114, and an MgO protective layer 104 are formed between a first substrate 100 and a second substrate 106 of the PDP 1.

The A electrodes A1 through to Am are formed on the second substrate 106 in a predetermined pattern. The second dielectric layer 110 is applied to cover the A electrodes A1 through to Am. On the second dielectric layer 110, the barrier ribs 114 are formed in parallel with the A electrodes A1 through to Am. The barrier ribs 114 define a discharge space in each discharge is cell, and prevent crosstalk between adjacent discharge cells. The phosphor layers 112 are disposed on the second dielectric layer 110 on the A electrodes A1 through to Am and between the barrier ribs 114, and include red emitting phosphor layers, green emitting phosphor layers, and blue emitting phosphor layers, that are sequentially arranged.

The X electrodes X1 through to Xn and the Y electrodes Y1 through to Yn are formed on the first substrate 100 in a predetermined pattern so that they intersect the A electrodes A1 through to Am. Discharge cells are set at points where the X electrodes X1 through to Xn and the Y electrodes Y1 through to Yn intersect. The X electrodes X1 through to Xn and the Y electrodes Y1 through to Yn may be fabricated by combining transparent conductive electrodes Xna and Yna, formed of a transparent conductive material, such as Indium Tin Oxide (ITO), with metal electrodes Xnb and Ynb that increase conductivity. The first dielectric layer 102 is coated onto the entire surface, of the resultant structure so as to cover the X electrodes X1 through to Xn and the Y electrodes Y1 through to Yn. The protective layer 104, such as an MgO layer, which protects the panel from a strong electric field, is coated onto the entire surface of the resultant structure so as to cover the first dielectric layer 102. The discharge space 108 is sealed with a gas for plasma generation.

A PDP driven by a driving apparatus according to an embodiment of the present invention is not limited to that of FIG. 2. That is, such a PDP may be a 2-electrode PDP in which only two electrodes are arranged, and not a 3-electrode PDP as in FIG. 2. Furthermore, various types of PDPs are available so long as they can be driven by the driving method according to an embodiment of the present invention.

FIG. 4 is a schematic diagram of the arrangement of the electrodes in the PDP 1 of FIG. 2. Referring to FIG. 4, the Y electrodes Y1 through to Yn and the X electrodes X1 through to Xn are arranged in parallel with one another. The A electrodes A1 through to Am intersect the Y electrodes Y1 through to Yn and the X electrodes X1 through to Xn, and a discharge cell Ce is defined at each intersection point.

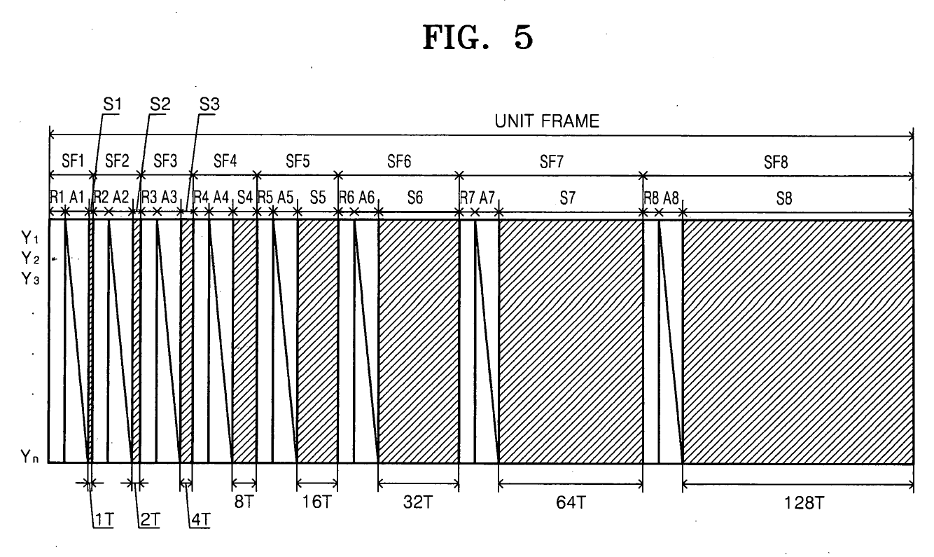

FIG. 5 is a timing diagram of a method of driving the PDP 1 of FIG. 2. Referring to FIG. 5, for a time-division gray-scale display, a unit frame may be divided into a predetermined number of subfields, e.g., eight subfields SF1 through to SF8. Each of the subfields SF1 through to SF8 is divided into reset periods R1 through to R8, address periods A1 through to A8, and sustain periods S1 through to S8.

In the reset periods R1 through to R8, initialization is performed by supplying a reset pulse to the Y electrodes Y1 through to Yn by equalizing wall charge conditions in all the cells.

In the address periods A1 through to A8, an address pulse is supplied to the A electrodes A1 through to Am, and at the same time, scan pulses corresponding to the Y electrodes Y1 through to Yn are sequentially supplied thereto.

In the sustain periods S1 through to S8, a sustain pulse is alternately supplied to the Y electrodes Y1 through to Yn and the X electrodes X1 through to Xn so as to generate a sustain discharge in discharge cells where wall charges are formed in the address periods A1 through to A8.

The brightness in the PDP is proportional to the total number of sustain discharge pulses in the sustain periods S1 through to S8 in the unit frame. For example, when a frame constituting an image is expressed with eight subfields and 256 gray scales, different numbers of sustain pulses may be allocated to the respective eight subfields at a ratio of 1:2:4:8:16:32:64:128. In order to achieve 133 gray-scale brightness, a sustain discharge is performed by addressing cells in the first subfield SF1, the third subfield SF3 and the eighth subfield SF8.

The total number of sustain discharges allocated to each subfield may be variably determined depending on weights allocated to the respective subfields according to an Automatic Power Control (APC) level, and variously changed in consideration of gamma characteristics or panel characteristics. For example, a grayscale level allocated to the fourth subfield SF4 can be lowered from 8 to 6, and a grayscale level allocated to the sixth subfield SF6 can be increased from 32 to 34. In addition, the number of subfields constituting a single frame can be variously changed according to design specifications.

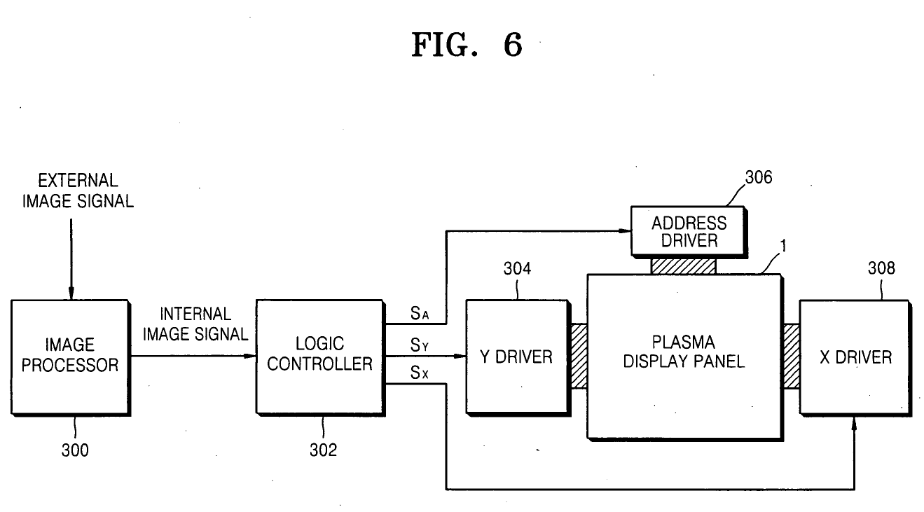

FIG. 6 is a schematic block diagram of an apparatus for driving the PDP 1 of FIG. 2 according to an embodiment of the present invention. Referring to FIG. 6, the apparatus includes an image processor 300, a logic controller 302, an address driver 306, an X driver 308 and a Y driver 304.

The image processor 300 transforms an external analog image signal into an internal digital signal that includes 8-bit red (R), green (G), blue (B) image data, a clock signal, and a vertical and horizontal synchronization signal, for example. The logic controller 302 generates driving control signals SA, SY, and SX in response to the image signal received from the image processor 300.

The address driver 306 generates display-data signals by processing the address signal SA of the driving control signals SA, SY, and SX received from the logic controller 302, and supplies the generated display data signals to the address electrode lines.

The X driver 308 processes the X driving control signal SX from among the driving control signals SA, SY, and SX received from the logic controller 302, and supplies the processed result to X electrode lines.

The Y driver 304 processes the Y driving control signal SY from among the driving control signals SA, SY, and SX received from the logic controller 302, and supplies the processed result to Y electrode lines.

In an embodiment of the present invention, when a sustain discharge pulse voltage Vs is supplied using an energy recovery circuit, the logic controller 302 adjusts the amount of light to be generated during a sustain discharge by differently setting a length of time in order to achieve the sustain discharge pulse voltage Vs according to an APC level and for each subfield. A method of adjusting the amount of light according to a weight allocated to each subfield and an APC level may be performed by controlling a turn-on time of a switch, included in the energy recovery circuit, which is used to achieve the sustain discharge pulse voltage Vs. This method is described below.

The logic controller 302 drives the PDP 1 by receiving an external R, G, and B image signal and a synchronization signal, dividing a single frame into several subfields, and dividing each of the subfields into a reset period, an address period and a sustain period. The logic controller 302 supplies a required control signal to the address driver 306, the X driver 308, and the Y driver 304 by adjusting the total number of sustain discharge pulses to be included in each sustain period of a subfield of the single frame. In an embodiment of the present invention, the logic controller 302 computes the APC level of a received image signal, and generates a control signal that controls a rising ramp of the sustain discharge pulse voltage Vs according to the APC level and a weight allocated to each subfield. The control signal is transmitted to the X driver 308 and the Y driver 304.

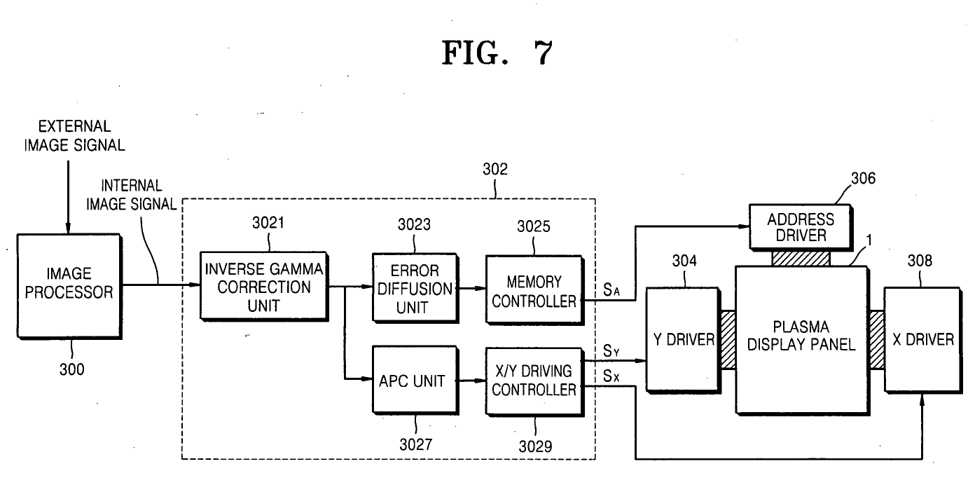

FIG. 7 is a schematic block diagram of the logic controller 302 of the PDP 1 according to an embodiment of the present invention. Referring to FIG. 7, the controller 302 includes an inverse gamma correction unit 3021, an error diffusion unit 3023, a memory controller 3025, an Automatic Power Control (APC) unit 3027, and an X/Y driving controller 3029.

The inverse gamma correction unit 3021 corrects n-bit R, G, and B image data, which is current input image data, into an m-bit image signal by mapping the n-bit R, G, and B image data to an inverse gamma curve (where m≧n). In a general PDP, n is 8 and m is 10 or 12.

The image signal input to the inverse gamma correction unit 3021 is a digital signal. If an analog image signal is input to the PDP, the analog signal must be converted into a digital image signal by using an analog-to-digital converter (ADC) (not shown). Also, the inverse gamma correction unit 3021 may include a lookup table (not shown) that stores data corresponding to an inverse gamma curve for mapping an image signal, or a logic circuit (not shown) that generates the data corresponding to the inverse gamma curve by performing a logic operation.

The error diffusion unit 3023 displays a lower m-n bit image of the m-bit image, which is inversely gamma corrected and extended by the inverse gamma correction unit 3021, by error-diffusing the lower m-n bit image to an adjacent pixel. Error diffusion is a technique whereby a lower bit that is to be error-diffused is displayed by separating an image for the lower bit and diffusing the image to an adjacent pixel (For details, see Korean Laid-Open Patent Gazette No. 2002-0014766).

The memory controller 3025 generates subfield data corresponding to the grayscale of the image signal received from the error diffusion unit 3023, and rearranges the subfield data as address data for driving the PDP. The memory controller 3025 separates all subfields of a single frame, separately stores the separated subfields in a frame memory (not shown), reads address data for all of the pixels from the frame memory in units of the subfields, and transmits the read address data to the address driver 306. The APC unit 3027 measures the rate of load by using the image data received from the inverse gamma correction unit 3021, and computes and outputs an APC level according to the measured rate of load.

The X/Y driving controller 3029 obtains the number of sustain discharge pulses of each of the frames, which is inversely proportional to the rate of load measured by the APC unit 3027; obtains the number of sustain discharge pulses of each subfield by using the number of sustain discharge pulses of the frame and a weight allocated to each subfield, and outputs a control signal that changes the amount of time required to achieve the sustain discharge pulse voltage so that the amount of time is inversely proportional to the number of sustain discharge pulses.

That is, the X/Y driving controller 3029 computes the total number of sustain pulses for each frame according to the APC level, and the total number of sustain pulses for each subfield, which corresponds to the total number of sustain pulses. In order to determine a number of sustain pulses, the X/Y driving controller 3029 computes the average signal level (ASL) of each frame, using the following Equation (1):

$$ASL = {\sum }_{x = 1}^{N} {\sum }_{y = 1}^{M} \frac{{R}_{x , y} + {G}_{x , y} + {B}_{x , y}}{3 \times N \times M} , \qquad ( 1 )$$

wherein Rx,y, Gx,y, and Bx,y respectively denote RGB grayscale values at a location (x,y), and N and M respectively denote the width and height of each frame. The X/Y driving controller 3029 determines a different number of sustain pulses (sustain discharge pulses) for each frame of the input image signal so that the number of sustain pulses corresponds to the APC level, in consideration of brightness and power consumption according to the ASL as given by Equation (1).

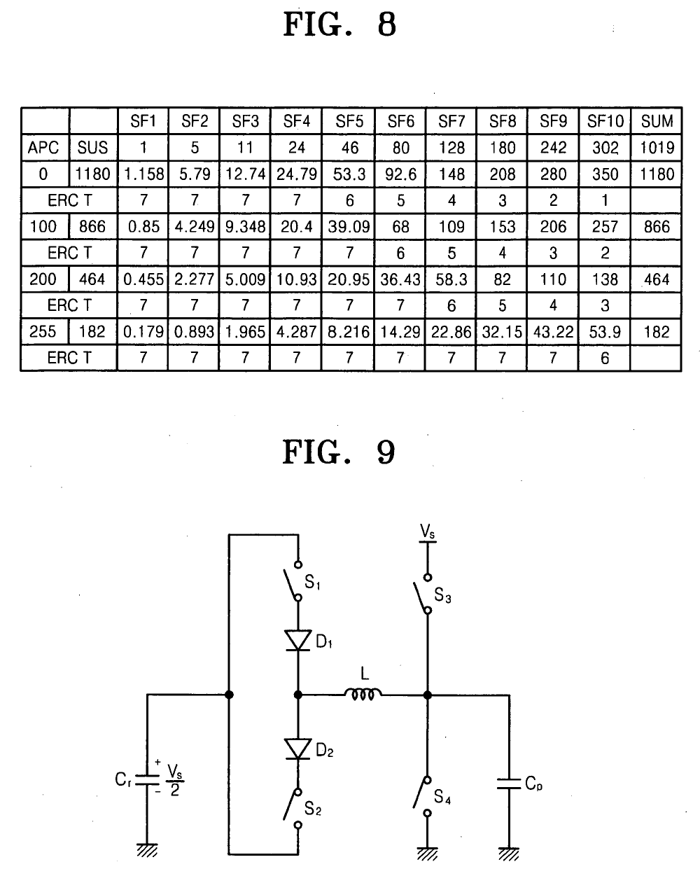

FIG. 8 is a table of a method of differently adjusting the amount of time required to achieve a sustain discharge pulse voltage according to an embodiment of the present invention. In FIG. 8, the number of sustain discharge pulses for each frame and subfield was determined on the assumption that the sustain discharge pulses are to be supplied to X electrodes or Y electrodes. Thus, the sum of the sustain discharge pulses that are to be actually supplied to the X electrodes and the Y electrodes is double the sum of FIG. 8.

Referring to FIG. 8, a single frame consists of 10 subfields SF1 through to SF10. A weight allocated to the single frame is 1019, and weights allocated to the 10 subfields SF1 through to SF10 of the single frame are 1, 5, 11, 24, 46, 80, 128, 180, 242, and 302, respectively.

The APC level corresponding to a piece of frame data of an input image signal is inversely proportional to the total number SUM of sustain discharge pulses for each frame. That is, if the APC level is increased from 0 to 255, the total number SUM of sustain discharge pulses to be allocated to a single frame is reduced from 1019 to 182.

Accordingly, the total number of sustain discharge pulses for each frame, which is determined according to the total number SUM of sustain discharge pulses for the frame and a weight allocated to each subfield, is also reduced. For example, the total number of sustain discharge pulses for the fifth subfield SF5 is gradually reduced to 53.3, 39.09, 20.85, and 8.216.

The total number of sustain discharge pulses for each subfield may be calculated by multiplying a ratio of a weight for the subfield to a weight for the frame by the total number SUM of the sustain discharge pulses for the frame. For example, when the APC level is 0, the total number of sustain discharge pulses for the fifth subfield SF5 is 46/1019×1180=53.3.

According to an embodiment of the present invention, the amount of time required to achieve the sustain pulse voltage is inversely proportional to the total number of sustain discharge pulses for a subfield. That is, the more sustain discharge pulses there are for a subfield, the less amount of time required to achieve the sustain pulse voltage. Conversely, the less sustain discharge pulses there are for a subfield, the more amount of time required to achieve the sustain pulse voltage. For example, when the APC level is 0, the total number of sustain discharge pulses for subfields is increased from 1.158 to 350, and a rising time required to achieve the sustain pulse voltage ERC T is reduced from 7 to 1 accordingly.

When the total number of sustain discharge pulses for a subfield, which are supplied to X electrodes and Y electrodes, is less than 100, the amount ERC T of time required to achieve the sustain pulse voltage is kept at a constant value of 7.

When the total number of sustain discharge pulses for a subfield, which are supplied to X electrodes and Y electrodes, is equal to or greater than 100, the amount ERC T of time required to achieve the sustain pulse voltage is reduced from 6 to 1 as the total number of sustain discharge pulses for a subfield becomes increased. The higher the APC level, the less subfields there are that require a short amount of time for achieving the sustain pulse voltage.

For example, if the total number of sustain discharge pulses, for a subfield, which are supplied to the X electrodes and the Y electrodes is from 100 to 150, the amount ERC T of time required to achieve the sustain pulse voltage may be set to 6. If the total number of sustain discharge pulses is from 150 to 220, the amount ERC T of time may be set to 5. If the total number of sustain discharge pulses is from 220 to 350, the amount ERC T of time maybe set to 4. If the total number of sustain discharge pulses is from 350 to 500, the amount ERC T of time may be set to 3. If the total number of sustain discharge pulses is from 500 to 680, the amount ERC T of time may be set to 2. If the total number of sustain discharge pulses is 700 or more, the amount ERC T of time may be set to 1.

The above table reveals that the limit of the total number of sustain discharge pulses to which the same amount ERC T of time is supplied, increases to 50, 70, 120, 150, and 180.

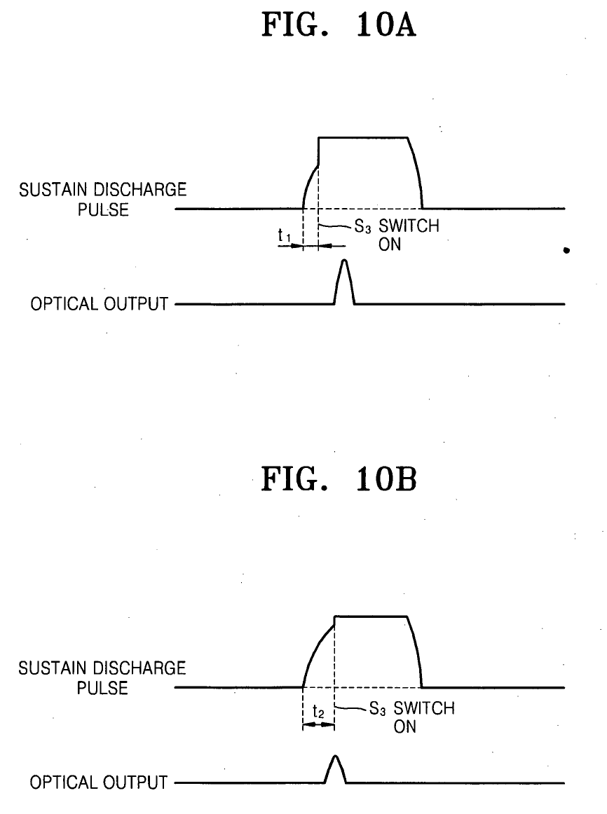

Hereinafter, a method of adjusting a rising ramp of the sustain discharge pulse voltage IS described with reference to FIGS. 9, 10A, and 10B.

FIG. 9 is a circuit diagram of an energy recovery circuit that supplies the sustain discharge pulse voltage Vs to a scan electrode or a sustain electrode. FIGS. 10A and 10B are waveforms of variations in an optical output versus a rising ramp of a sustain discharge pulse.

The energy recovery circuit of FIG. 9, which retrieves and reuses reactive power, has been introduced by L. F. Weber. A detailed description of the energy recovery circuit has been omitted since this circuit is presented in U.S. Pat. Nos. 4,866,349 and 5,081,400.

Referring to FIG. 9, a switch S1 is turned on in order to supply the sustain discharge pulse voltage Vs to a sustain electrode or a scan electrode (which corresponds to a first or second terminal of a panel capacitor Cp of FIG. 9). As a result, a resonance path is formed by a capacitor Cr, an inductor L, and the panel capacitor Cp, and thus, the voltage of the first terminal of the panel capacitor Cp (which corresponds to a sustain electrode or a scan electrode) is increased around the sustain discharge pulse voltage Vs. Next, while the voltage of the first terminal of the panel capacitor Cp is increased around the sustain discharge pulse voltage Vs, a switch S3 is turned on so as to clamp the voltage of the first terminal of the panel capacitor Cp to the sustain discharge pulse voltage Vs. In this way, the sustain discharge pulse voltage Vs can be supplied to the sustain electrode or the scan electrode.

As illustrated in FIGS. 10A and 10B, the intensity of an optical output varies depending on whether an interval between when the switch S1 is turned on and the switch S3 is turned on is t1 or t2. That is, as illustrated in FIG. 10A, when the switch S2 is turned on the interval t2, which is a comparatively short time, sustain discharge pulses are clamped to sustain discharge pulse voltage Vs for a short time, and thus, the intensity of the optical output is strong. As illustrated in FIG. 10B, the switch S3 is turned on after the interval t2, which is a comparatively long time, the amount of time required to clamp the sustain discharge pulses to the sustain discharge pulse voltage Vs becomes longer due to resonance between the inductor L and the capacitor Cp, and therefore, the intensity of the optical output is weak. In this case, as illustrated in FIGS. 10A and 10B, the rising ramps of the sustain discharge pulses are different from one another. As described above with reference to FIGS. 9, 10A and 10B, a method of differently adjusting the amount of time required to achieve the sustain discharge pulse voltage according to an embodiment of the present invention may be performed by adjusting the turn-on times of the switches S1 and S3.

Referring to FIG. 7, as described above, the X/Y driving controller 3029 generates a control signal for switch timing, and transmits it to the X and Y drivers 308 and 304 in order to differently adjust a rising ramp of the sustain discharge pulse voltage.

Each of the X and Y drivers 308 and 304 includes an energy recovery circuit as illustrated in FIG. 9, receives a switch control signal, which is generated based on an APC level and a weight allocated to a subfield, from the X/Y driving controller 3029, and supplies the sustain discharge pulse voltage Vs to the scan electrodes Y1 through to Yn and the scan electrodes X1 through to Xn, based on the switch control signal.

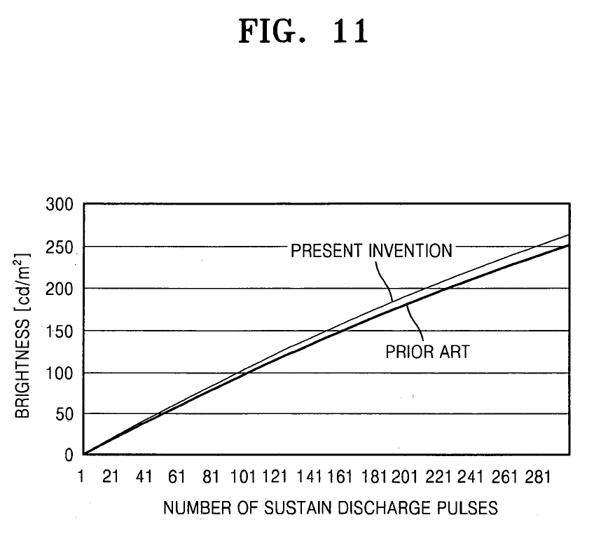

FIG. 11 is a graph of an improvement in the brightness saturation phenomenon, according to an embodiment of the present invention. Referring to FIG. 11, the present embodiment improves the brightness saturation phenomenon caused by an increase in the total number of sustain discharge pulses, which is a problem with the conventional method, thereby overcoming the gray-scale inversion phenomenon and realizing luminance linearity.

As described above, according to a method of driving a PDP according to an embodiment of the present invention, it is possible to efficiently improve the brightness saturation phenomenon caused by an increase in the total number of sustain discharge pulses, thereby overcoming the gray-scale inversion phenomenon and realizing luminance linearity.

While this invention has been particularly shown and described with reference to exemplary embodiments thereof, it will be understood by those skilled in the art that various modifications in form and detail may be made therein without departing from the spirit and scope of the present invention as defined by the appended claims.

What is claimed is:

1. A method of driving a Plasma Display Panel (PDP) in which a sustain discharge is performed by a plurality of first and second electrodes, the method comprising:
providing a number of sustain discharge pulses based on a rate of load of an input signal; and
alternately and respectively supplying first and second voltages to the first and second electrodes in a sustain period according to the provided number of sustain discharge pulses, the second voltage being greater than the first voltage;
wherein a duration in which the first voltage is increased to the second voltage, is inversely proportional to the number of sustain discharge pulses for the subfield.

2. The method of claim 1, wherein providing the number of sustain discharge pulses comprises:
obtaining a number of sustain discharge pulses for each frame which is inversely proportional to the rate of load of the input signal; and
obtaining a number of sustain discharge pulses for each subfield in accordance with the number of sustain discharge pulses for each frame and a weight allocated to each subfield.

3. The method of claim 2, wherein, when the number of sustain discharge pulses for the subfield is less than a predetermined number, the duration in which the voltage is increased from the first voltage to the second voltage is kept constant.

4. The method of claim 2, wherein, when the number of sustain discharge pulses for the subfield is less than 100, the duration in which the voltage is increased from the first voltage to the second voltage is kept constant.

5. The method of claim 2, wherein, the subfields are divided into a plurality of groups according to a limit of the sustain discharge pulses for the subfield; and wherein the duration in which the voltage is increased from the first voltage to the second voltage is the same for the subfields belonging to each group.

6. The method of claim 5, wherein the more sustain discharge pulses there are belonging to a group, the greater limit the sustain discharge pulses belonging to the group have.

7. The method of claim 2, wherein the number of the sustain discharge pulses for each subfield is calculated by multiplying a ratio of a weight for the subfield to a weight for the frame by the number of sustain discharge pulses for the frame.

8. The method of claim 1, wherein the duration that the first voltage is increased to the second voltage is controlled according to the timing of a switch of an energy recovery circuit electrically connected to either the first electrodes or the second electrodes.
